(19) United States
(12) Patent Application Publication
(10) Pub. No.: US 2026/0281062 A1
(43) Pub. Date: Sep. 17, 2026

(54) NETWORK PACKET PROCESSING APPARATUS WITH MULTI-CORE PARALLEL PROCESSING CAPABILITY AND PACKET ORDER PRESERVATION CAPABILITY AND RELATED NETWORK PACKET PROCESSING METHOD

(71) Applicant: Airoha Technology (Suzhou) Limited, Suzhou City (CN)

(72) Inventors: WEIHUA HUANG, Nanjing City (CN); Fei Yan, Nanjing City (CN); PENG DU, Nanjing City (CN)

(73) Assignee: Airoha Technology (Suzhou) Limited, Suzhou City (CN)

(21) Appl. No.: 19/260,308

(22) Filed: Jul. 4, 2025

(30) Foreign Application Priority Data
Mar. 13, 2025 (CN) 202510294786.0

(51) Int. Cl. H04L 49/90; H04L 49/102

(52) U.S. Cl. CPC H04L 49/9036; H04L 49/102

(57) ABSTRACT

A network packet processing apparatus includes a receive (RX) ring buffer, a transmit (TX) ring buffer, a plurality of queues, a plurality of first processor cores, and a second processor core. The first processor cores read a plurality of groups of RX packet descriptors in turn according to a polling order, and perform parallel processing upon a plurality of groups of packets. Each first processor core generates at least one TX packet descriptor and at least one queue element for a group of packets, and pushes the at least one queue element into a corresponding queue, where the at least one queue element has an end flag asserted therein. The second processor core reads the queues in turn according to the polling order. When reading the end flag, the second processor core switches to read a next queue according to the polling order.

### BACKGROUND OF THE INVENTION

### 1. Field of the Invention

The present invention relates to packet forwarding, and more particularly, to a network packet processing apparatus with multi-core parallel processing capability and packet order preservation capability and a related network packet processing method.

### 2. Description of the Prior Art

A gateway is a common network device used to connect different networks and forward packets from one network to another, such as packet forwarding between a wired network and a wireless network. A network processing unit (NPU) is a high-speed programmable processor specifically used for packet processing (e.g., packet forwarding). It has some functions and architectures that can be used to accelerate the processing efficiency of packets. However, as network bandwidth continues to increase, packets are transmitted at a higher rate, which requires the NPU to be able to quickly process these high-speed ingress packets. A traditional solution may use a multi-core NPU. Multi-core parallel processing can effectively improve the processing performance and packet forwarding throughput of the NPU. However, since the packet processing speeds of different processor cores of the NPU may be different from each other, multi-core parallel processing may cause packets to be out of order. Therefore, there is a need for an innovative design which is capable of leveraging multi-core parallel processing technology to improve packet forwarding performance while still preserving the order of packets.

### SUMMARY OF THE INVENTION

One of the objectives of the claimed invention is to provide a network packet processing apparatus with multi-core parallel processing capability and packet order preservation capability and a related network packet processing method.

According to a first aspect of the present invention, an exemplary network packet processing apparatus is disclosed. The exemplary network packet processing apparatus includes a receive (RX) ring buffer, a transmit (TX) ring buffer, a plurality of queues, a plurality of first processor cores, and a second processor core. The RX ring buffer has a plurality of storage blocks each arranged to buffer an RX packet descriptor of a packet before the packet is processed. The TX ring buffer has a plurality of storage blocks each arranged to buffer a TX packet descriptor of the packet after the packet has been processed. The plurality of first processor cores are arranged to read a plurality of groups of RX packet descriptors in turn according to a polling order, and perform parallel processing upon a plurality of packets according to the plurality of groups of RX packet descriptors, wherein the plurality of queues are allocated to the plurality of first processor cores, respectively, each first processor core of the plurality of first processor cores is arranged to generate at least one TX packet descriptor and at least one queue element corresponding to the at least one TX packet descriptor for a group of packets, and push the at least one queue element into a corresponding queue included in the plurality of queues, where the at least one queue element comprises an end flag asserted therein. The second processor core is arranged to read the plurality of queues in turn according to the polling order, and write a TX packet descriptor corresponding to a queue element read from each queue into the TX ring buffer, wherein when the second processor core reads the end flag from a current queue, the second processor core switches to read a next queue according to the polling order.

According to a second aspect of the present invention, an exemplary network packet processing method is disclosed. The exemplary network packet processing method includes: using a plurality of first processor cores to read a plurality of groups of receive (RX) packet descriptors buffered in an RX ring buffer in turn according to a polling order, and perform parallel processing upon a plurality of packets according to the plurality of groups of RX packet descriptors, wherein the RX ring buffer has a plurality of storage blocks each arranged to buffer an RX packet descriptor of a packet before the packet is processed; allocating a plurality of queues to the plurality of first processor cores, respectively; using each first processor core of the plurality of first processor cores to generate at least one TX packet descriptor and at least one queue element corresponding to the at least one TX packet descriptor for a group of packets, and push the at least one queue element into a corresponding queue included in the plurality of queues, wherein the at least one queue element comprises an end flag asserted therein; and using a second processor core to read the plurality of queues in turn according to the polling order, and write a transmit (TX) packet descriptor corresponding to a queue element read from each queue into a TX ring buffer, wherein the TX ring buffer has a plurality of storage blocks each arranged to buffer a TX packet descriptor of the packet after the packet has been processed, and when the second processor core reads the end flag from a current queue, the second processor core switches to read a next queue according to the polling order.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a network packet processing apparatus according to an embodiment of the present invention.

FIG. 2 is a flowchart of an operation process of a processor core in FIG. 1 that is used as a processing core.

FIG. 3 is a diagram of a TX packet descriptor format according to an embodiment of the present invention.

FIG. 4 is a diagram of an aggregated packet format according to an embodiment of the present invention.

FIG. 5 is a flowchart of an operation process of a processor core in FIG. 1 that is used as an order-preserving core.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

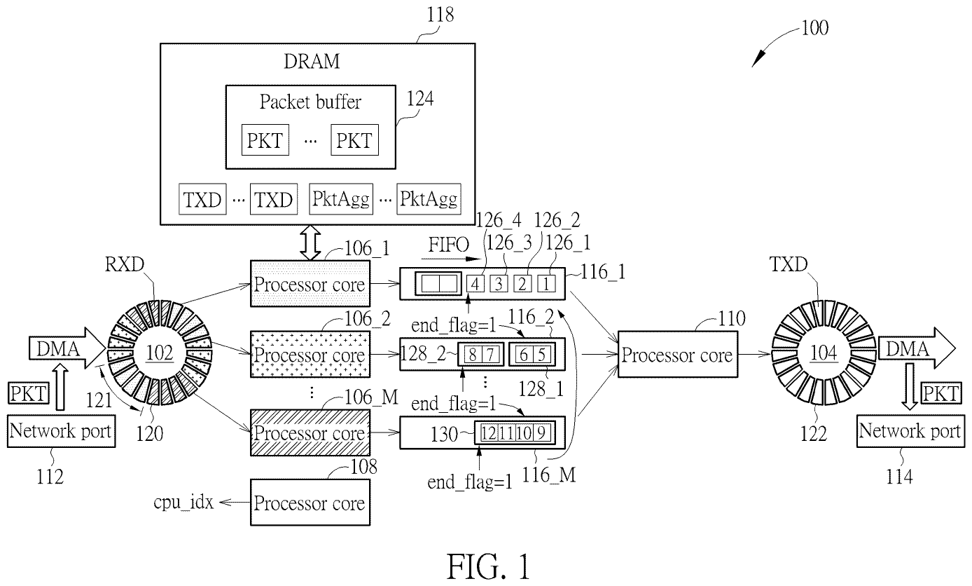

FIG. 1 is a diagram of a network packet processing apparatus according to an embodiment of the present invention. For example, the network packet processing apparatus 100 may be used by a network device (e.g., a gateway). As shown in FIG. 1, the network packet processing apparatus 100 may include a receive (RX) ring buffer 102, a transmit (TX) ring buffer 104, a plurality of processor cores 106_1-106_M (M≥2), 108, 110, a plurality of network ports 112, 114, a plurality of queues 116_1 to 116_M (M≥2), and a dynamic random access memory (DRAM) 118. It should be noted that only the components pertinent to the present invention are illustrated in FIG. 1. In practice, the network packet processing apparatus 100 may include additional components to achieve designated functions.

The network packet processing apparatus 100 receives a plurality of packets (i.e., network packets) PKT from the network port 112, and then a direct memory access (DMA) controller (not shown) copies and writes each packet PKT to a packet buffer 124 allocated in the DRAM 118. When initialization of the packet buffer 124 is performed, the packet buffer 124 may be divided into a plurality of storage blocks according to a fixed block size, wherein these storage blocks are used to store a plurality of packets PKT, respectively. In this embodiment, the packet buffer 124 is allocated in the DRAM 118, but the present invention is not limited thereto. In practice, the packet buffer 124 may be allocated in any component with data storage capability. For example, in another embodiment, the packet buffer 124 may be allocated in a static random access memory (SRAM).

In this embodiment, the processor cores 106_1-106_M, 108, 110 may be located in the same multi-core NPU, wherein the processor cores 106_1-106_M may be used as processing cores, and the processor core 110 may be used as an order-preserving core. In addition, in order to address the RX ring buffer update issue that may be caused by multi-core racing between the processor cores 106_1-106_M, the present embodiment may use another processor core 108 (which is not any of the processor cores 106_1-106_M) to deal with the updating of the CPU index cpu_idx that is used to indicate the use status of the RX ring buffer 102, without intervention of the processor cores 106_1-106_M.

The RX ring buffer 102 and the TX ring buffer 104 may be allocated in an SRAM, but the present invention is not limited thereto. The RX ring buffer 102 is allocated for handling the reception of packets PKT from the network port 112. The TX ring buffer 104 is allocated for handling the transmission of packets PKT to be forwarded via the network port 114 under the control of the DMA controller (not shown). Specifically, the RX ring buffer 102 is divided into a plurality of storage blocks 120, each used to buffer an RX packet descriptor RXD of a packet PKT before the packet PKT is processed, and the TX ring buffer 104 is divided into a plurality of storage blocks 122, each used to buffer a TX packet descriptor TXD of a packet PKT after the packet PKT has been processed. Each packet descriptor may record some metadata of a corresponding packet. For example, the packet descriptor may have a plurality of fields, including a packet length field pkt_len, a packet address field pkt_addr, etc. Hence, the processor cores 106_1-106_M may refer to the metadata recorded in the RX packet descriptor to read the information carried by the corresponding packet stored in the DRAM 118, and then perform certain packet processing to generate a processed packet to be subsequently forwarded through the network port 114. After processing of a packet is completed, the processor cores 106_1-106_M generates a TX packet descriptor of the packet to be forwarded, and the processor core 110 writes the TX packet descriptor of the to-be-forwarded packet into the TX ring buffer 104 under the premise of preserving the order of packets. The DMA controller can refer to the metadata recorded in the TX packet descriptor to read the corresponding packet from the DRAM 118 for packet forwarding.

In this embodiment, the processor cores 106_1-106_M are used to perform parallel processing of packets, and the processor core 110 is used to ensure that the order of packets is preserved. In other words, the network packet processing apparatus 100 has multi-core parallel processing capability and packet order preservation capability. The operational details of multi-core parallel processing and packet order preservation are described as below with reference to the accompanying drawings.

First, the network packet processing apparatus 100 performs initialization. The plurality of storage blocks 120 of the RX ring buffer 102 are sequentially divided into a plurality of groups of storage blocks 121, and each group of storage blocks in the plurality of groups of storage blocks 121 is used to store a group of RX packet descriptors. The number of storage blocks in each group (i.e., the number of RX packet descriptors in each group) can be adjusted according to actual design considerations. For example, each group of storage blocks 121 includes A consecutive storage blocks 120, and the RX ring buffer 102 can be divided into B groups of storage blocks in total. In other words, the RX ring buffer 102 is divided into B groups of storage blocks according to A consecutive RX packet descriptors RXD per group. For example, A=8 and B=192. However, the present invention is not limited thereto. In addition, the value of a packet aggregation number Agg_Num is initialized to 1 (i.e., Agg_Num=1), and the length of each of the queues 116_1-116_M is L. Therefore, each queue 116_i (i={1, 2, . . . , M}) can store L queue elements. In this embodiment, each queue element may include a TX packet descriptor address field TXD_address and an end flag field end_flag. The queues 116_1-116_M are initialized to all 0's.

After the network port 112 starts receiving a plurality of packets PKT, corresponding RX packet descriptors of the plurality of packets PKT are written into the RX ring buffer 102. When the RX ring buffer 102 has RX packet descriptors to be processed, the processor cores 106_1-106_M can read the RX packet descriptors from the RX ring buffer 102 to perform packet forwarding processing. As mentioned above, the RX ring buffer 102 is divided into B groups according to A consecutive RX packet descriptors RXD per group. Therefore, the RX packet descriptors RXD stored in the RX ring buffer 102 can be divided into B groups of RX packet descriptors. The processor cores 106_1-106_M read B groups of RX packet descriptors in the RX ring buffer 102 in turn according to a polling order (e.g., 1→2→. . . →M→1→. . . ). Assuming that the number of B groups of RX packet descriptors is 192(B=192), the number of RX packet descriptors in each group of RX packet descriptors is 8 (A=8), and the number of processor cores 106_1-106_M is 3(M=3), start addresses of the 192 groups of RX packet descriptors are sequentially assigned to the processor cores 106_1-106_3, and each processor core processes 64 groups of RX packet descriptors, each of which includes 8 RX packet descriptors RXD, wherein the processor core 106_1 is responsible for processing the (1+3*k)^{th} group of RX packet descriptors (k={0, 1, . . . , 63}), the processor core 106_2 is responsible for processing the (2+3*k)^{th} group of RX packet descriptors (k={0, 1, . . . , 63}), and the processor core 106_3 is responsible for processing the (3+3*k)^{th} group of RX packet descriptors (k={0, 1, . . . , 63}).

In addition, the processor cores 106_1-106_M process a plurality of groups of packets in parallel according to the plurality of groups of RX packet descriptors that are obtained by the processor cores 106_1-106_M respectively. In other words, during a period in which one processor core processes a group of packets (e.g., 8 packets) according to a group of RX packet descriptors obtained from the RX ring buffer 102, another processor core may process another group of packets (e.g., 8 packets) according to another group of RX packet descriptors obtained from the RX ring buffer 102. Since the network packet processing apparatus 100 has multi-core parallel processing capability, the overall packet forwarding efficiency can be improved.

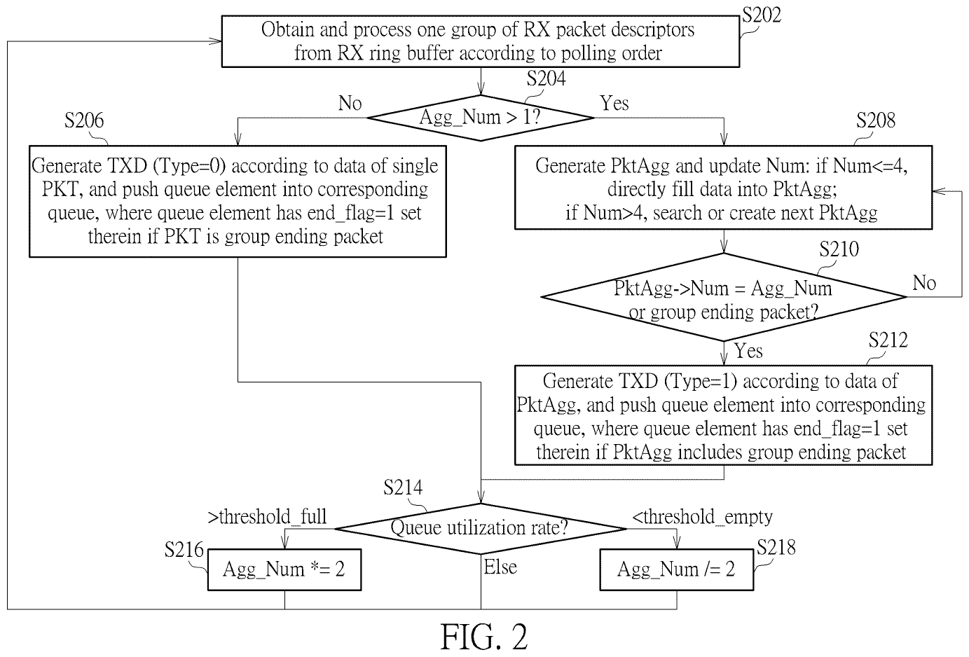

Please refer to FIG. 1 in conjunction with FIG. 2. FIG. 2 is a flowchart of an operation process of any processor core 106_i (i={1, 2, . . . , M}) included in the processor cores 106_1-106_M shown in FIG. 1. Provided that the result is substantially the same, the steps are not required to be executed in the exact order shown in FIG. 2. In step S202, the processor core 106_i (i={1, 2, . . . , M}) follows the polling order to obtain a group of RX packet descriptors (e.g., 8 RX packet descriptors RXD) from the RX ring buffer 102 for processing a group of packets (e.g., 8 packets corresponding to the 8 RX packet descriptors RXD). In step S204, the processor core 106_i (i={1, 2, . . . , M}) determines whether the current value of the packet aggregation number Agg_Num is greater than 1 (i.e., determines whether packet aggregation is required to reduce the load of the order-preserving core (i.e., processor core 110)). As mentioned above, the TX ring buffer 104 is allocated for handling the transmission of packets PKT to be forwarded via the network port 114 under the control of the DMA controller (not shown). In this embodiment, the DMA controller (not shown) for performing packet forwarding can support reading and forwarding of multiple packets (which are aggregated in a same aggregated packet) through a single TX packet descriptor TXD. In addition, the value of the packet aggregation number Agg_Num is initialized to 1 (i.e., Agg_Num=1). However, the actual value of the packet aggregation number Agg_Num will be dynamically adjusted according to a utilization rate of the queue 116_i (i={1, 2, . . . , M}) that is allocated to the processor core 106_i (i={1, 2, . . . , M}).

Assuming that the current value of the packet aggregation number Agg_Num is not larger than 1, the process enters step S206. In step S206, the processor core 106_i (i={1, 2, . . . , M}) generates a TX packet descriptor TXD according to data of a single packet PKT, and buffers the TX packet descriptor TXD in a storage device (e.g., DRAM 118). In this embodiment, the TX packet descriptor TXD generated by the processor core 106_i (i={1, 2, . . . , M}) in step S206 is buffered in the DRAM 118. However, the present invention is not limited thereto. In practice, the TX packet descriptor TXD may be buffered in any component with data storage capability. For example, in another embodiment, the TX packet descriptor TXD generated by the processor core 106_i (i={1, 2, . . . , M}) can be buffered in an SRAM.

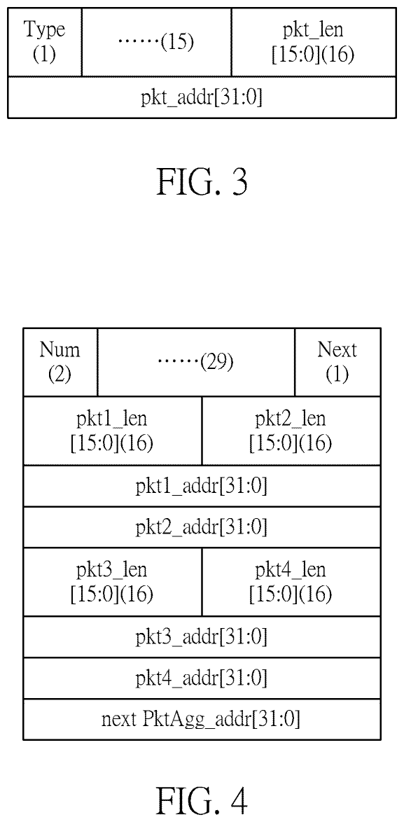

FIG. 3 is a diagram of a TX packet descriptor format according to an embodiment of the present invention. The TX packet descriptor TXD has a plurality of fields, such as a type field Type (1 bit), a packet length field pkt_len (16 bits), a packet address field pkt_addr (32 bits), etc. The type field Type is used to indicate the type of the TX packet descriptor TXD. For example, when the processor core generates the TX packet descriptor TXD according to data of a single packet PKT, the type field Type is written with a logic value “0” (i.e., Type=0), and when the processor core generates the TX packet descriptor TXD according to data of an aggregated packet PktAgg (which is formed through aggregating multiple packets PKT), the type field Type will be written with a logic value “1” (i.e., Type=1). In addition, the packet address field pkt_addr is used to indicate an address of a packet in the storage device, where the packet corresponds to the TX packet descriptor TXD. For example, when the processor core 106_i (i={1, 2, . . . , M}) generates the TX packet descriptor TXD based on the data of a single packet PKT, the packet address field pkt_addr records an address of the single packet PKT in a storage device (e.g., packet buffer 124 allocated in DRAM 118). When the processor core 106_i (i={1, 2, . . . , M}) generates the TX packet descriptor TXD according to data of an aggregated packet PktAgg (which is formed by aggregating multiple packet PKTs), the packet address field pkt_addr records an address of the aggregated packet PktAgg in a storage device (e.g., DRAM 118).

In step S206, after the processor core 106_i (i={1, 2, . . . , M}) generates a TX packet descriptor TXD according to the data of the single packet PKT, it also generates a queue element according to the TX packet descriptor TXD (Type=0) and pushes the queue element into the corresponding queue 116_i (i={1, 2, . . . , M}), wherein the TX packet descriptor address field TXD_address of the queue element is written with an address of the TX packet descriptor TXD (Type=0) in the storage device (e.g., DRAM 118). In addition, whether the end flag field end_flag of the queue element is set to 1 (i.e., end_flag=1) is determined according to whether the single packet PKT corresponding to the TX packet descriptor TXD (Type=0) is a group ending packet (i.e., the last packet in a group of packets corresponding to a group of RX packet descriptors obtained from the RX ring buffer 102 in step S202). In other words, if the single packet PKT corresponding to the TX packet descriptor TXD (Type=0) is not the group ending packet, the end flag field end_flag of the queue element is written with a logical value “0” (i.e., end_flag=0), such that the queue element has no end flag asserted therein. On the other hand, if the single packet PKT corresponding to the TX packet descriptor TXD (Type=0) is the group ending packet, the end flag field end_flag of the queue element is written with a logical value “1” (i.e., end_flag=1) such that the queue element has the end flag asserted therein.

Assuming that step S204 judges that the current value of the packet aggregation number Agg_Num is larger than 1, the process enters step S208. In step S208, the processor core 106_i (i={1, 2, . . . , M}) generates an aggregated packet PktAgg and buffers the aggregated packet PktAgg in a storage device (e.g., DRAM 118). In this embodiment, the aggregated packet PktAgg generated by the processor core 106_i (i={1, 2, . . . , M}) in step S208 is buffered in the DRAM 118. However, the present invention is not limited thereto. In practice, the aggregated packet PktAgg may be buffered in any component with data storage capability. For example, in another embodiment, the aggregated packet PktAgg generated by the processor core 106_i (i={1, 2, . . . , M}) may be buffered in an SRAM.

FIG. 4 is a diagram of an aggregated packet format according to an embodiment of the present invention. In this embodiment, each aggregated packet PktAgg can be formed by aggregating up to 4 packets PKT, and has a plurality of fields, such as a packet aggregation number field Num, a linked to next aggregated packet field Next, four packet length fields pkt1_len (16 bits), pkt2_len (16 bits), pkt3_len (16 bits), pkt1_len (16 bits), four packet address fields pkt1_addr (32 bits), pkt2_addr (32 bits), pkt3_addr (32 bits), pkt4_addr (32 bits), a next aggregated packet address next PktAgg_addr (32 bits), etc. The packet aggregation number field Num is used to indicate the number of packets that are aggregated by packet aggregation. The maximum number of packets that are aggregated in a same aggregated packet is 4. Hence, the value of the packet aggregation number field Num will be updated with the number of packets that participate in the packet aggregation. If the number of packets that need to be aggregated exceeds 4 (i.e., Num>4), the current aggregated packet PktAgg can be linked to the next aggregated packet PktAgg through the linked to next aggregated packet field Next (Next=1) and the next aggregated packet address next PktAgg_addr. If the number of packets that need to be aggregated is not larger than 4 (i.e., Num≤4), the linked to next aggregated packet field Next is written with the logic value “0” (i.e., Next=0), indicating that the current aggregated packet PktAgg does not need to be linked to a next aggregated packet PktAgg.

The packet address field pkt1_addr is used to indicate an address of the first packet PKT participating in the packet aggregation in the storage device (e.g., packet buffer 124 allocated in DRAM 118), the packet address field pkt2_addr is used to indicate an address of the second packet PKT participating in the packet aggregation in the storage device (e.g., packet buffer 124 allocated in DRAM 118), the packet address field pkt3_addr is used to indicate an address of the third packet PKT participating in the packet aggregation in the storage device (e.g., packet buffer 124 allocated in DRAM 118), and the packet address field pkt4_addr is used to indicate an address of the fourth packet PKT participating in the packet aggregation in the storage device (e.g., packet buffer 124 allocated in DRAM 118). In addition, the packet length field pkt1_len is used to indicate a packet length of the first packet PKT participating in the packet aggregation, the packet length field pkt2_len is used to indicate a packet length of the second packet PKT participating in the packet aggregation, the packet length field pkt3_len is used to indicate a packet length of the third packet PKT participating in the packet aggregation, and a packet length field pkt4_len is used to indicate the packet length of the fourth packet PKT participating in the packet aggregation.

In this embodiment, the processor core 106_i (i={1, 2, . . . , M}) generates the aggregated packet PktAgg according to the current value of the packet aggregation number Agg_Num. When the value of the packet aggregation number field Num is updated with the number of packets participating in the packet aggregation and reaches the value of the packet aggregation number Agg_Num (step S210), the process enters step S212. In addition, when the value of the packet aggregation number field Num does not reach the value of the packet aggregation number Agg_Num yet and the aggregated packet PktAgg already includes a group ending packet (i.e., the last packet in a group of packets corresponding to a group of RX packet descriptors obtained by the processor core from the RX ring buffer 102 in step S202), since the aggregated packet PktAgg already includes all packets in the same group of packets, the process also enters step S212.

In step S212, after the processor core 106_i (i={1, 2, . . . , M}) generates a TX packet descriptor TXD according to data of the aggregated packet PktAgg and buffers the TX packet descriptor TXD in a storage device (e.g., DRAM 118), a queue element is generated according to the TX packet descriptor TXD (Type=1) and the queue element is pushed into the corresponding queue 116_i (i={1, 2, . . . , M}), wherein the TX packet descriptor address field TXD_address of the queue element is written with an address of the TX packet descriptor TXD (Type=1) in the storage device (e.g., DRAM 118). In addition, whether the end flag field end_flag of the queue element is set by 1 (i.e., end_flag=1) is determined according to whether the aggregated packet PktAgg corresponding to the TX packet descriptor TXD (Type=1) includes a group ending packet (i.e., the last packet in a group of packets corresponding to a group of RX packet descriptors obtained from the RX ring buffer 102 in step S202). In other words, if the aggregated packet PktAgg corresponding to the TX packet descriptor TXD (Type=1) does not include the group ending packet, the end flag field end_flag of the queue element is written with a logical value “0” (i.e., end_flag=0) such that the queue element has no end flag asserted therein. On the other hand, if the aggregated packet PktAgg corresponding to the TX packet descriptor TXD (Type=1) includes the group ending packet, the end flag field end_flag of the queue element is written with a logical value “1” (i.e., end_flag=1) such that the queue element has the end flag asserted therein. In the present embodiment, the TX packet descriptor TXD generated by the processor core 106_i (i={1, 2, . . . , M}) in step S212 is buffered in the DRAM 118. However, the present invention is not limited thereto. In practice, the TX packet descriptor TXD may be buffered in any component with data storage capability. For example, in another embodiment, the TX packet descriptor TXD generated by the processor core 106_i (i={1, 2, . . . , M}) may be buffered in an SRAM.

The processor cores 106_1-106_M are used as processing cores to read M groups of RX packet descriptors, each of which includes a plurality of RX packet descriptors RXD, from the RX ring buffer 102, and perform multi-core parallel processing upon a plurality of packets according to the M groups of RX packet descriptors. The processed packets will enter the queues 116_1-116_M in the form of queue elements, where the queues 116_1-116_M are allocated to the processor cores 106_1-106_M, respectively. Therefore, the processor core 106_i (i={1, 2, . . . , M}) sequentially pushes corresponding queue elements of processed packets into the corresponding queue 116_i (i={1, 2, . . . , M}). In order to achieve packet order preservation, the network packet processing apparatus 100 uses a dedicated order-preserving core (i.e., processor core 110) to read queue elements in the queues 116_1-116_M and write TX packet descriptors TXD into the TX ring buffer 104 in a correct order. However, when the queue 116_i (i={1, 2, . . . , M}) is close to its storage capacity limit, it means that the order-preserving core (i.e., processor core 110) is about to reach its processing capability limit. In order to reduce the load of the order-preserving core (i.e., processor core 110), the processor core 106_i (i={1, 2, . . . , M}) can enable the packet aggregation function to effectively reduce the number of to-be-processed queue elements in the queue 116_i (i={1, 2, . . . , M}). In step S214, the processor core 106_i (i={1, 2, . . . , M}) checks a utilization rate (e.g., a percentage of to-be-processed queue elements) of the corresponding queue 116_i (i={1, 2, . . . , M}). When the utilization rate of the queue 116_i (i={1, 2, . . . , M}) is higher than one threshold threshold_full, the processor core 106_i (i=1, 2, . . . , M) increases the value of the packet aggregation number Agg_Num (e.g., Agg_Num =Agg_Num*2) (step S216). When the utilization rate of the queue 116_i (i={1, 2, . . . , M}) is lower than another threshold threshold_empty, the processor core 106_i (i={1, 2, . . . , M}) decreases the value of the packet aggregation number Agg_Num (e.g., Agg_Num =Agg_Num/2) (step S218). In addition, if the utilization rate of the queue 116_i (i={1, 2, . . . , M}) is between these two thresholds threshold_full and threshold_empty, the processor core 106_i (i={1, 2, . . . , M}) may keep the current value of the packet aggregation number Agg_Num unchanged.

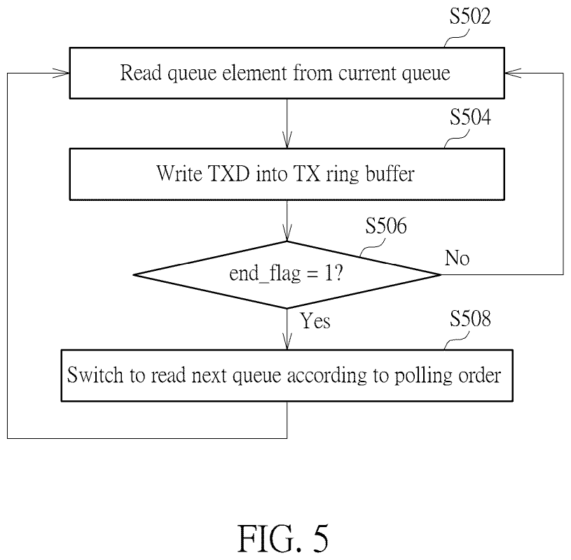

As mentioned above, the processor core 110 is used as an order-preserving core. In this embodiment, the processor core 110 reads the queues 116_1-116_M allocated to the processor cores 106_1-106_M in turn according to the same polling order (i.e., the polling order in which the processor cores 106_1-106_M read the plurality of RX packet descriptors in the RX ring buffer 102 in turn), and writes a TX packet descriptor TXD corresponding to a queue element read from each queue 116_i (i={1, 2, . . . , M}) into the TX ring buffer 104. When the processor core 110 reads the end flag end_flag=1 from a current queue, it switches to read a next queue according to the polling order. Please refer to FIG. 1 in conjunction with FIG. 5. FIG. 5 is a flowchart of an operation process of the processor core 110 shown in FIG. 1. In step S502, the processor core 110 refers to the polling order (e.g., 1→2→. . . M→1→. . . ) to start reading each queue element from a current queue. Each queue of the queues 116_1-116_M outputs its queue elements to the processor core 110 one by one according to the first in first out (FIFO) principle. Whenever the processor core 110 reads a current queue element from the current queue, it reads a TX packet descriptor TXD from the storage device (e.g., DRAM 118) according to an address recorded in the TX packet descriptor address field TXD_address in the current queue element, and writes the TX packet descriptor TXD to the TX ring buffer 104 (step S504). In step S506, the processor core 110 checks if the end flag end_flag=1 is set for the current queue element. If the current queue element does not have the end flag end_flag=1 set therein, the processor core 110 continues to read a next queue element from the current queue, where the next queue element becomes the current queue element to be read from the current queue (step S502). If the current queue element has the end flag end_flag=1 set therein, the processor core 110 refers to the polling order to switch to read a next queue (step S508), and then the process returns to step S502.

In summary, the network packet processing apparatus 100 of the present invention utilizes the processor cores 106_1-106_M as processing cores to perform multi-core parallel processing of a plurality of packets, and utilizes a dedicated processor core 110 as an order-preserving core to preserve the order of the plurality of packets after the multi-core parallel processing is done. In addition, regarding the order-preserving processing of packets, the processor cores 106_1-106_M take turns to read a plurality of groups of RX packet descriptors from the RX ring buffer 102 in a polling order, the dedicated processor core 110 follows the same polling order to read queues 116_1-116_M allocated to the processor cores 106_1-106_M, and an end flag in a queue element that corresponds to a group ending packet is asserted, such that the dedicated processor core 110 can write the corresponding TX packet descriptors into the TX ring buffer 104 in sequence according to the order in which the packets are received. As shown in FIG. 1, it is assumed that each group of RX packet descriptors has 4 RX packet descriptors, the number of processing cores is 3 (M=3), and the polling order is 1→2→3→1→2→3→. . . . Hence, the processor core 106_1 sequentially pushes four queue elements 126_1, 126_2, 126_3, 126_4 into the corresponding queue 116_1, wherein the queue elements 126_1, 126_2, 126_3, 126_4 correspond to four consecutive packets (labeled as 1, 2, 3, and 4), respectively, and the queue element 126_4 has an end flag end_flag=1 set therein. The processor core 106_2 sequentially pushes two queue elements 128_1, 128_2 into the corresponding queue 116_2, wherein the queue element 128_1 corresponds to an aggregated packet (Num=2) including two consecutive packets (labeled as 5 and 6), the queue element 128_2 corresponds to an aggregated packet (Num=2) including two consecutive packets (labeled as 7 and 8), and the queue element 128_2 has an end flag end_flag=1 set therein. The processor core 106_M pushes a queue element 130 into the corresponding queue 116_M, wherein the queue element 130 corresponds to an aggregated packet (Num=4) including four consecutive packets (labeled as 9, 10, 11, 12), and the queue element 130 has an end flag end_flag=1 set therein. Since the polling sequence is 1→2→3→1→2→3→. . . , the processor core 110 first reads the queue 116_1. When the processor core 110 reads the queue 116_1, it reads the queue elements 126_1, 126_2, 126_3, 126_4 in sequence. Since the end flag end_flag is asserted in the queue element 126_4, after reading the queue element 126_4, the processor core 110 switches to read a next queue (i.e., queue 116_2) according to the polling sequence 1→2→3→1→2→3→. . . . When the processor core 110 reads the queue 116_2, it reads the queue elements 128_1 and 128_2 in sequence. Since the end flag end_flag is asserted in the queue element 128_2, after reading the queue element 128_2, the processor core 110 switches to read a next queue (i.e., queue 116_M) according to the polling order 1→2→3→1→2→3→. . . . When the processor core 110 reads the queue 116_M, it reads the queue element 130. Since the end flag end_flag is asserted in the queue element 130, after reading the queue element 130, the processor core 110 switches to read a next queue (i.e., queue 116_1) according to the polling order 1→2→3→1→2→3→. . . .

The network packet processing apparatus 100 of the present invention does not need to assign an additional sequence number to each packet received by the network port 112 for subsequently preserving the order of packets through the additional sequence numbers, which can reduce the overhead. In addition, when the order-preserving core (i.e., processor core 110) approaches its processing capability limit, the load of the order-preserving core (i.e., processor core 110) is reduced by dynamically aggregating packets at the processing cores (i.e., processor cores 106_1-106_M), which not only ensures that the order of packets is preserved, but also greatly improves the overall packet forwarding efficiency through multi-core parallel processing, thereby maximizing the potential of parallel processing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network packet processing apparatus comprising:
a receive (RX) ring buffer, having a plurality of storage blocks each arranged to buffer an RX packet descriptor of a packet before the packet is processed;
a transmit (TX) ring buffer, having a plurality of storage blocks each arranged to buffer a TX packet descriptor of the packet after the packet has been processed;
a plurality of queues;
a plurality of first processor cores, arranged to read a plurality of groups of RX packet descriptors in turn according to a polling order, and perform parallel processing upon a plurality of packets according to the plurality of groups of RX packet descriptors, wherein the plurality of queues are allocated to the plurality of first processor cores, respectively, each first processor core of the plurality of first processor cores is arranged to generate at least one TX packet descriptor and at least one queue element corresponding to the at least one TX packet descriptor for a group of packets, and push the at least one queue element into a corresponding queue included in the plurality of queues, where the at least one queue element comprises an end flag asserted therein; and
a second processor core, arranged to read the plurality of queues in turn according to the polling order, and write a TX packet descriptor corresponding to a queue element read from each queue into the TX ring buffer, wherein when the second processor core reads the end flag from a current queue, the second processor core switches to read a next queue according to the polling order.

2. The network packet processing apparatus of claim 1, wherein the plurality of groups of RX packet descriptors have a same number of RX packet descriptors.

3. The network packet processing apparatus of claim 2, wherein the plurality of storage blocks of the RX ring buffer are sequentially divided into a plurality of groups of storage blocks, and each group of storage blocks included in the plurality of groups of storage blocks is arranged to store a group of RX packet descriptors.

4. The network packet processing apparatus of claim 1, wherein each queue element comprises a TX packet descriptor address field and an end flag field, the TX packet descriptor address field is arranged to indicate an address of a TX packet descriptor in a storage device, and the end flag field is arranged to indicate whether the end flag is asserted.

5. The network packet processing apparatus of claim 1, wherein a queue element that is included in the at least one queue element and corresponds to a last packet of the group of packets has the end flag asserted therein.

6. The network packet processing apparatus of claim 1, wherein the group of packets comprises a first packet, the at least one TX packet descriptor comprises only a first TX packet descriptor that corresponds to the first packet, and the at least one queue element comprises a first queue element that corresponds to the first TX packet descriptor.

7. The network packet processing apparatus of claim 6, wherein each first processor core of the plurality of first processor cores is further arranged to set a packet aggregation number according to a utilization rate of the corresponding queue, and generate the first TX descriptor when determining that the packet aggregation number is not larger than 1.

8. The network packet processing apparatus of claim 1, wherein the group of packets comprises a plurality of first packets, the at least one TX packet descriptor comprises a first TX packet descriptor that corresponds to the plurality of first packets, and the at least one queue element comprises a first queue element that corresponds to the first TX packet descriptor.

9. The network packet processing apparatus of claim 8, wherein each first processor core of the plurality of first processor cores is further arranged to set a packet aggregation number according to a utilization rate of the corresponding queue, and generate the first TX descriptor when determining that the packet aggregation number is larger than 1.

10. The network packet processing apparatus of claim 9, wherein the each first processor core of the plurality of first processor cores is further arranged to generate an aggregated packet when determining that the packet aggregation number is larger than 1; the aggregated packet is formed by aggregating the plurality of first packets; and a packet address field of the first TX packet descriptor records an address of the aggregated packet in a storage device.

11. A network packet processing method comprising:
using a plurality of first processor cores to read a plurality of groups of receive (RX) packet descriptors buffered in an RX ring buffer in turn according to a polling order, and perform parallel processing upon a plurality of packets according to the plurality of groups of RX packet descriptors, wherein the RX ring buffer has a plurality of storage blocks each arranged to buffer an RX packet descriptor of a packet before the packet is processed;
allocating a plurality of queues to the plurality of first processor cores, respectively;
using each first processor core of the plurality of first processor cores to generate at least one TX packet descriptor and at least one queue element corresponding to the at least one TX packet descriptor for a group of packets, and push the at least one queue element into a corresponding queue included in the plurality of queues, wherein the at least one queue element comprises an end flag asserted therein; and
using a second processor core to read the plurality of queues in turn according to the polling order, and write a transmit (TX) packet descriptor corresponding to a queue element read from each queue into a TX ring buffer, wherein the TX ring buffer has a plurality of storage blocks each arranged to buffer a TX packet descriptor of the packet after the packet has been processed, and when the second processor core reads the end flag from a current queue, the second processor core switches to read a next queue according to the polling order.

12. The network packet processing method of claim 11, wherein the plurality of groups of RX packet descriptors have a same number of RX packet descriptors.

13. The network packet processing method of claim 12, further comprising:
sequentially dividing the plurality of storage blocks of the RX ring buffer into a plurality of groups of storage blocks; and
using each group of storage blocks included in the plurality of groups of storage blocks to store a group of RX packet descriptors.

14. The network packet processing method of claim 11, wherein each queue element comprises a TX packet descriptor address field and an end flag field, the TX packet descriptor address field is arranged to indicate an address of a TX packet descriptor in a storage device, and the end flag field is arranged to indicate whether the end flag is asserted.

15. The network packet processing method of claim 11, wherein a queue element that is included in the at least one queue element and corresponds to a last packet of the group of packets has the end flag asserted therein.

16. The network packet processing method of claim 11, wherein the group of packets comprises a first packet, the at least one TX packet descriptor comprises only a first TX packet descriptor that corresponds to the first packet, and the at least one queue element comprises a first queue element that corresponds to the first TX packet descriptor.

17. The network packet processing method of claim 16, further comprising:
using each first processor core of the plurality of first processor cores to set a packet aggregation number according to a utilization rate of the corresponding queue, and generate the first TX descriptor when determining that the packet aggregation number is not larger than 1.

18. The network packet processing method of claim 11, wherein the group of packets comprises a plurality of first packets, the at least one TX packet descriptor comprises a first TX packet descriptor that corresponds to the plurality of first packets, and the at least one queue element comprises a first queue element that corresponds to the first TX packet descriptor.

19. The network packet processing method of claim 18, further comprising:
using each first processor core of the plurality of first processor cores to set a packet aggregation number according to a utilization rate of the corresponding queue, and generate the first TX descriptor when determining that the packet aggregation number is larger than 1.

20. The network packet processing method of claim 19, further comprising:
using the each first processor core of the plurality of first processor cores to generate an aggregated packet when determining that the packet aggregation number is larger than 1, wherein the aggregated packet is formed by aggregating the plurality of first packets, and a packet address field of the first TX packet descriptor records an address of the aggregated packet in a storage device.
